(19) United States
(12) Patent Application Publication
(10) Pub. No.: US 2026/0111380 A1
(43) Pub. Date: Apr. 23, 2026

(54) SENDING COMMUNICATION DATA TO NODES IN A COMMUNICATION FABRIC

(71) Applicant: International Business Machines Corporation, Armonk, NY (US)

(72) Inventors: Seamus J. Burke, Tucson, AZ (US); Maoyun Tang, Tucson, AZ (US); Todd C. Sorenson, Tucson, AZ (US)

(21) Appl. No.: 18/924,223

(22) Filed: Oct. 23, 2024

(51) Int. Cl. G06F 13/40; G06F 13/24

(52) U.S. Cl. CPC G06F 13/4022; G06F 13/24; G06F 2213/0026; G06F 2213/2418

(57) ABSTRACT

Methods, systems, and computer program products for automatically sending communication data to multiple nodes within a communication fabric are provided herein. A computer-implemented method includes receiving communication data within a communication fabric; determining at least one signal type associated with at least a portion of the communication data; encoding information pertaining to the at least one determined signal type associated with the at least a portion of the communication data into one or more data representations; and transmitting the one or more data representations to multiple nodes within the communication fabric.

### BACKGROUND

The present application generally relates to information technology and, more particularly, to system componentry. More specifically, in certain environments, there may be multiple nodes within a system that seek to communicate in a peripheral component interconnect express (PCIe) fabric. However, in conventional systems, there is typically only one controlling node whose root complex receives error signals. Also, in such conventional systems, the other node(s) will not directly receive these error signals, and if the controlling node is failing and/or not functioning properly, important information may be lost and/or not properly transmitted, potentially leading to system damage and/or resource wastage.

### SUMMARY

In at least one embodiment, techniques for automatically sending communication data to multiple nodes within a communication fabric of a computer are provided.

An example computer-implemented method can include receiving communication data within a communication fabric, and determining at least one signal type associated with at least a portion of the communication data. Additionally, the method includes encoding information pertaining to the at least one determined signal type associated with the at least a portion of the communication data into one or more data representations. Further, the method includes transmitting the one or more data representations to multiple nodes within the communication fabric.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating example system architecture for sending PCIe messages and/or signals to multiple hosts, according to an example embodiment of the invention;

FIG. 2 is a flow diagram illustrating techniques according to an example embodiment of the invention; and

FIG. 3 is a diagram illustrating a computing environment in which at least one embodiment of the invention can be implemented.

### DETAILED DESCRIPTION

As described herein, at least one embodiment includes at least one system and methods for sending PCIe communications (e.g., messages and/or signals) to multiple nodes within at least one communication fabric of a computer. As used herein, the terms “host” and “node” are used synonymously, and the term “peripheral device” refers to a downstream device which can be responsible, for example, for sending a signal.

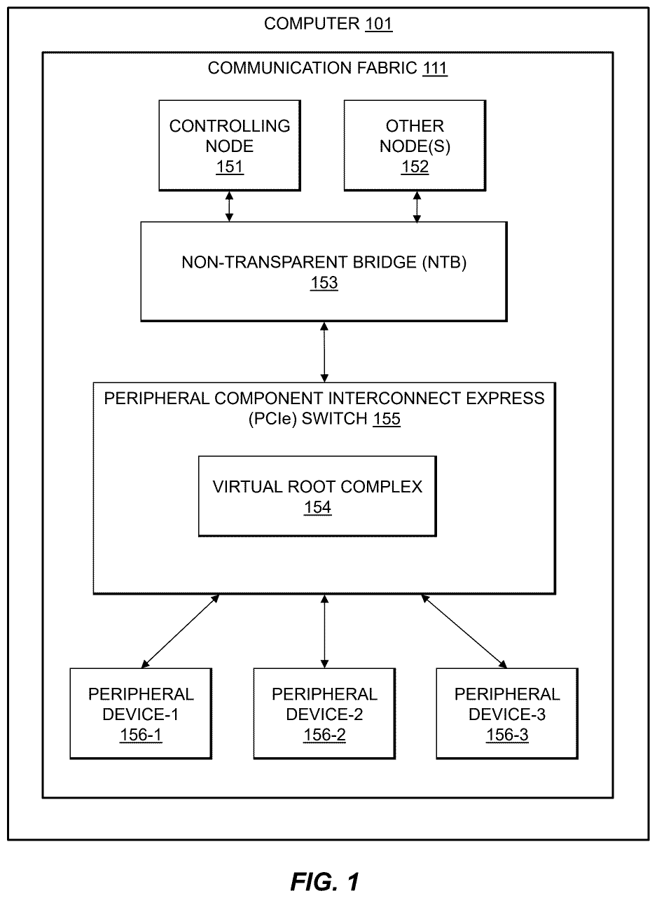

FIG. 1 is a diagram illustrating example system architecture for sending PCIe messages and/or signals to multiple nodes within a system, according to an example embodiment of the invention. By way of illustration, FIG. 1 depicts a communication fabric 111 of computer 101. Within and/or as part of communication fabric 111, one or more embodiments include processing and/or receiving, using a virtual root complex 154 within switch PCIe 155, communication data. As used herein, a virtual root complex refers to a stand-alone root complex that resides within a switch, in contrast to a standard root complex, which has the backing of a computer system and/or connects to a full computer system.

In at least one embodiment, the communication data can include a designed set of communications such as, for example, all error signals and message signaled interrupts (MSIs) associated with computer 101. Responsive to processing and/or receiving the given communication data (e.g., an error signal and/or MSI), the virtual root complex 154 performs one or more functions. For example, for each node attached to the communication fabric 111, including controlling node 151 and one or more other nodes 152, the virtual root complex 154 determines the type of communication (e.g., based at least in part on a field such as “message code” in the given communication) categorizing the given communication data (e.g., a fatal error signal, a non-fatal error signal, an MSI), wherein such categorization information can be sent to and/or used by one or more particular nodes such as other node(s) 152, and/or one or more peripheral devices such as peripheral device-1 (156-1), peripheral device-2 (156-2) and peripheral device-3 (156-3). Additionally, in one or more embodiments, the virtual root complex 154 can also encode the determined type of communication in at least one bitmap. By way of example, in such an embodiment, each signal type can be mapped to a bit in a map (e.g., a fatal error signal can be mapped to bit 0).

Further, the virtual root complex 154 can send a communication (e.g., an MSI), via PCIe switch 155 and non-transparent bridge (NTB) 153, to each attached node (e.g., controlling node 151 and the one or more other nodes 152) to notify each attached node of the received given communication data. In one or more embodiments, the communication sent by the virtual root complex 154 to the attached nodes can include the at least one bitmap on which the determined type of communication has been encoded. The attached nodes can then read the at least one bitmap using an atomic self-clear mechanism, wherein once the read of the at least one bitmap occurs and/or is completed, a second read will indicate a zero status in order to prevent stale signals after acknowledgement. Additionally and/or optionally, in one or more embodiments, the virtual root complex 154 can also send the bitmap to peripheral devices 156-1, 156-2, and 156-3.

Additionally, in at least one embodiment, the attached and/or receiving nodes (e.g., controlling node 151 and/or the one or more other nodes 152) can perform virtual masking on the received communication upon a determination that the given node will not be handling an event associated with the communication (e.g., performing an action in response to the communication). By way of example, in such an embodiment, when the communication fabric 111 is configured, the attached nodes (e.g., controlling node 151, other node(s) 152, etc.) will communicate with one another and determine which node should be designated as the owner of the communication fabric 111 and thus have more responsibility on actions performed in the communication fabric 111. For instance, at least one of the one or more other nodes 152 can implement a virtual mask on the received at least one bitmap, indicating that the given node can ignore the given communication data, upon a determination by the given node that the given node will not be handling an event(s) associated with the bitmap. Once the ownership of the communication fabric 111 has been determined by communication among nodes, a predetermined mask can be used, indicating which events should be responded to by the owner.

Accordingly, as depicted in FIG. 1, one or more embodiments include a system and techniques related thereto for sending communication data (e.g., error signal information) to multiple nodes (e.g., all nodes) attached to a particular fabric (e.g., communication fabric 111). This allows, by way of example, for all nodes within a fabric to be notified of error situations (e.g., at the same time) such that at the nodes can start performing one or more respective actions in response to the error(s), as necessary and in a timely manner.

As such, and by way merely of illustration, consider an example scenario wherein an error signal or MSI is received and processed directly by the virtual root complex 154. In one or more embodiments, for each node (e.g., controlling node 151 and/or one or more other nodes 152) attached to communication fabric 111, a summary of the type of error signal or MSI received will be determined and/or set by the virtual root complex 154. Further, this summary can be encoded, by the virtual root complex 154, in a bitmap and sent (e.g., as part of an MSI) to each of the attached nodes to notify the nodes of the new error signal or MSI.

Each attached node will respond by reading the bitmap and determining whether it (i.e., the given node reading the bitmap) needs to act on the new error signal or MSI. In at least one embodiment, the bitmap can be read by each attached node using an atomic self-clear mechanism, such that that once a read occurs, a second read will indicate a zero status, which precludes stale signals after acknowledgement. The attached nodes can then, in one or more embodiments, apply a virtual mask to the bitmap if the bitmap is associated with one or more events that the given node has determined does not require action(s). Accordingly, by implementing a virtual mask on the bitmap summary, a given node could subsequently ignore the new error signal or MSI.

At least one embodiment of the present invention may provide a beneficial effect such as, for example, informing all nodes within a communication fabric of new error signals and/or MSIs, thereby facilitating faster and more efficient remediation actions within corresponding systems and reducing and/or preventing system failures and/or related resource wastage.

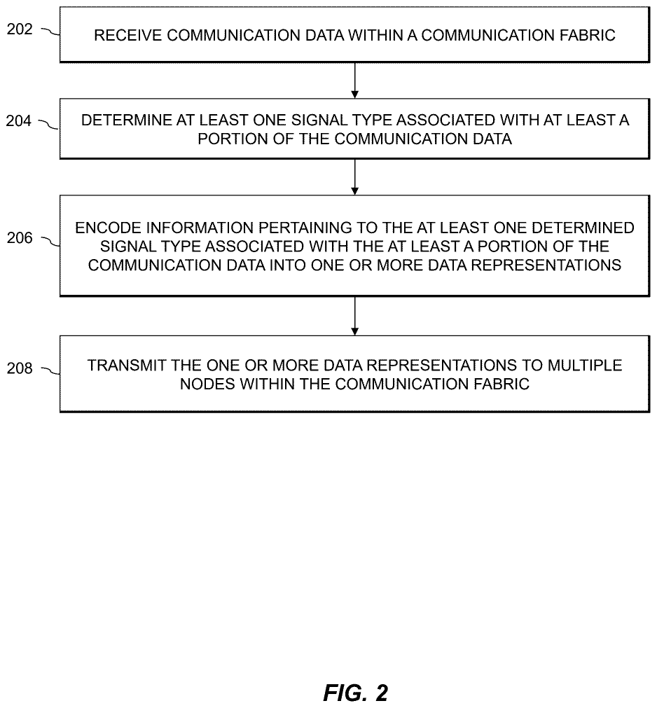

FIG. 2 is a flow diagram illustrating techniques according to an embodiment of the present invention. Step 202 includes receiving communication data within a communication fabric. In at least one embodiment, receiving communication data comprises receiving at least one of one or more error signals and one or more MSIs. Additionally or alternatively, receiving communication data can include receiving the communication data via at least one virtual root complex implemented in association with at least one PCIe switch in the communication fabric.

Step 204 includes determining at least one signal type associated with at least a portion of the communication data. In one or more embodiments, determining at least one signal type associated with at least a portion of the communication data includes determining the at least one signal type via at least one virtual root complex implemented in association with at least one PCIe switch in the communication fabric.

Step 206 includes encoding information pertaining to the at least one determined signal type associated with the at least a portion of the communication data into one or more data representations. In at least one embodiment, encoding information pertaining to the at least one determined signal type includes encoding the information pertaining to the at least one determined signal type into one or more bitmaps. Additionally or alternatively, encoding information pertaining to the at least one determined signal type can include encoding the information pertaining to the at least one determined signal type via at least one virtual root complex implemented in association with at least one PCIe switch in the communication fabric.

Step 208 includes transmitting the one or more data representations to multiple nodes within the communication fabric. In one or more embodiments, transmitting the one or more data representations to multiple nodes within the communication fabric includes transmitting the one or more data representations to the multiple nodes via at least one virtual root complex implemented in association with at least one PCIe switch in the communication fabric.

In at least one embodiment, the techniques depicted in FIG. 2 can also include determining, for at least one given node of the multiple nodes, whether one or more actions are to be carried out by the at least one given node based at least in part on processing the one or more data representations. In such an embodiment, determining whether one or more actions are to be carried out by the at least one given node can include determining, via the at least one given node, whether one or more actions are to be carried out in connection with the communication data based at least in part on the at least one given node processing the one or more data representations. Also, such an embodiment can additionally include implementing at least one virtual mask in connection with the one or more data representations based at least in part on results of determining whether one or more actions are to be carried out by the at least one given node.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as virtual root complex implementation code 326. In addition to virtual root complex implementation code 326, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and virtual root complex implementation code 326, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

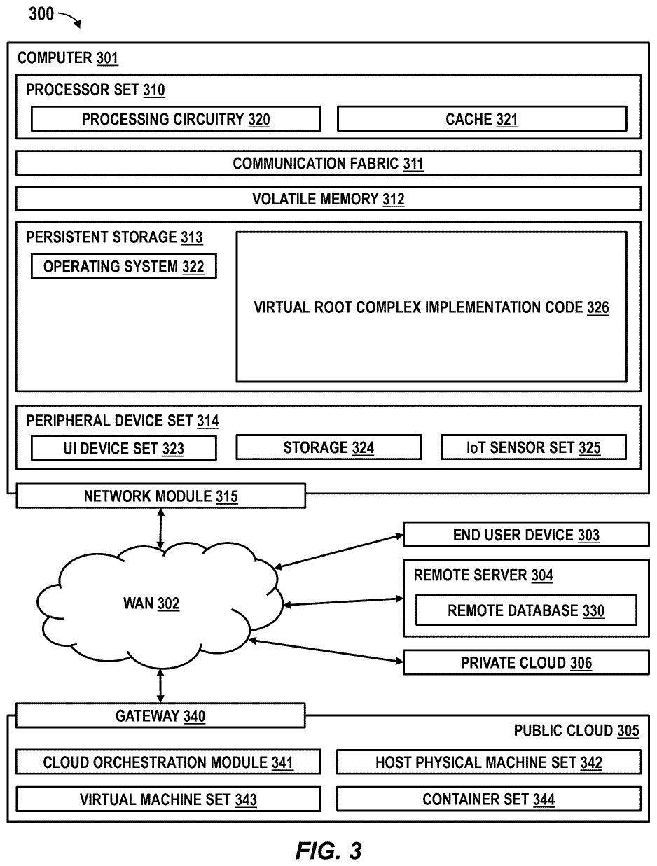

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in virtual root complex implementation code 326 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths. By way merely of example communication fabric 311 can include a PCIe communication fabric, such as depicted via communication fabric 111 in FIG. 1.

Volatile memory 312 is any type of volatile memory now known or to be developed in the future. Examples include dynamic type RAM or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a ROM, but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in virtual root complex implementation code 326 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

In computing environment 300, computer 301 is shown as being connected to the internet (see WAN 302). However, in many embodiments of the present invention computer 301 will be isolated from communicating over communications network and not connected to the internet, running as a standalone computer. In these embodiments, network module 315 of computer 301 may not be necessary or even desirable in order to ensure isolation and to prevent external communications coming into computer 301. The standalone computer embodiments are potentially advantageous, at least in some applications of the present invention, because they are typically more secure. In other embodiments, computer 301 is connected to a secure WAN or a secure LAN instead of WAN 302 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory configured to store program instructions; and
a processor operatively coupled to the memory to execute the program instructions to:
receive communication data within a communication fabric;
determine at least one signal type associated with at least a portion of the communication data;
encode information pertaining to the at least one determined signal type associated with the at least a portion of the communication data into one or more data representations; and
transmit the one or more data representations to multiple nodes within the communication fabric.

2. The system of claim 1, wherein receiving communication data comprises receiving at least one of one or more error signals and one or more message signaled interrupts (MSIs).

3. The system of claim 1, wherein receiving communication data comprises receiving the communication data via at least one virtual root complex implemented in association with at least one peripheral component interconnect express (PCIe) switch in the communication fabric.

4. The system of claim 1, wherein determining at least one signal type associated with at least a portion of the communication data comprises determining the at least one signal type via at least one virtual root complex implemented in association with at least one PCIe switch in the communication fabric.

5. The system of claim 1, wherein encoding information pertaining to the at least one determined signal type comprises encoding the information pertaining to the at least one determined signal type into one or more bitmaps.

6. The system of claim 1, wherein encoding information pertaining to the at least one determined signal type comprises encoding the information pertaining to the at least one determined signal type via at least one virtual root complex implemented in association with at least one PCIe switch in the communication fabric.

7. The system of claim 1, wherein transmitting the one or more data representations to multiple nodes within the communication fabric comprises transmitting the one or more data representations to the multiple nodes via at least one virtual root complex implemented in association with at least one PCIe switch in the communication fabric.

8. The system of claim 1, wherein the processor is further operatively coupled to the memory to execute the program instructions to:
determine, for at least one given node of the multiple nodes, whether one or more actions are to be carried out by the at least one given node based at least in part on processing the one or more data representations.

9. The system of claim 8, wherein determining whether one or more actions are to be carried out by the at least one given node comprises determining, via the at least one given node, whether one or more actions are to be carried out in connection with the communication data based at least in part on the at least one given node processing the one or more data representations.

10. The system of claim 8, wherein the processor is further operatively coupled to the memory to execute the program instructions to:
implement at least one virtual mask in connection with the one or more data representations based at least in part on results of determining whether one or more actions are to be carried out by the at least one given node.

11. A computer program product comprising a computer readable storage medium having program instructions embodied therewith, the program instructions executable by a computing device to cause the computing device to:
receive communication data within a communication fabric;
determine at least one signal type associated with at least a portion of the communication data;
encode information pertaining to the at least one determined signal type associated with the at least a portion of the communication data into one or more data representations and
transmit the one or more data representations to multiple nodes within the communication fabric.

12. The computer program product of claim 11, wherein receiving communication data comprises receiving at least one of one or more error signals and one or more MSIs.

13. The computer program product of claim 11, wherein encoding information pertaining to the at least one determined signal type comprises encoding the information pertaining to the at least one determined signal type into one or more bitmaps.

14. The computer program product of claim 11, wherein the program instructions executable by a computing device further cause the computing device to:
determine, for at least one given node of the multiple nodes, whether one or more actions are to be carried out by the at least one given node based at least in part on processing the one or more data representations.

15. The computer program product of claim 14, wherein the program instructions executable by a computing device further cause the computing device to:
implement at least one virtual mask in connection with the one or more data representations based at least in part on results of determining whether one or more actions are to be carried out by the at least one given node.

16. A computer-implemented method comprising:
receiving communication data within a communication fabric;
determining at least one signal type associated with at least a portion of the communication data;
encoding information pertaining to the at least one determined signal type associated with the at least a portion of the communication data into one or more data representations; and
transmitting the one or more data representations to multiple nodes within the communication fabric;
wherein the method is carried out by at least one computing device.

17. The computer-implemented method of claim 16, wherein receiving communication data comprises receiving at least one of one or more error signals and one or more MSIs.

18. The computer-implemented method of claim 16, wherein encoding information pertaining to the at least one determined signal type comprises encoding the information pertaining to the at least one determined signal type into one or more bitmaps.

19. The computer-implemented method of claim 16, comprising:
determining, for at least one given node of the multiple nodes, whether one or more actions are to be carried out by the at least one given node based at least in part on processing the one or more data representations.

20. The computer-implemented method of claim 19, comprising:
implementing at least one virtual mask in connection with the one or more data representations based at least in part on results of determining whether one or more actions are to be carried out by the at least one given node.
